(19) United States
(12) Patent Application Publication
(10) Pub. No.: US 2009/0126487 A1
(43) Pub. Date: May 21, 2009

(54) SYSTEM AND DEVICE FOR MEASURING THE ROTATIONAL SPEED OF A MOTOR VEHICLE WHEEL WITH INTEGRATED ACCELERATION SENSOR

(75) Inventors: Ludovic Boiste, Plaisir (FR); Pascal Gouriet, Chatillon (FR); Zahir Djama, Paris (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES SA, Velizy Villacoublay (FR)

(21) Appl. No.: 12/067,170

(22) PCT Filed: Sep. 11, 2006
(86) PCT No.: PCT/FR2006/050863

§ 371 Date: Aug. 29, 2008

(30) Foreign Application Priority Data
Sep. 16, 2005 (FR) 0509500

(51) Int. Cl. G01P 1/02

(52) U.S. Cl. 73/494

(57) ABSTRACT

The invention concerns a device for measuring the rotational speed of a vehicle wheel, comprising a housing (22), a printed circuit board (32) accommodated in the housing and an encoder cell (38) mounted on the printed circuit board and adapted to measure electromagnetic field variations. The device comprises at least one accelerometer (44;46) mounted on the printed circuit board (32) for measuring an acceleration along a first predetermined axis. The accelerometer may be mounted inclined relative to the plane of the printed circuit board.

The present invention concerns a device and a system for measuring the rotation speed of a wheel, in particular a motor vehicle wheel, and an acceleration thereof.

The invention concerns, in particular, the integration of at least one accelerometer in an ABS sensor.

The operation of a vehicle, such as its braking or its trajectory, is currently monitored using measurements of rotation speeds of the wheels of the vehicle. These measurements are supplied by rotation speed sensors mounted on the wheels, generally called “ABS sensors.”

An ABS sensor typically includes a coder disk mounted on the shaft of a wheel of the vehicle and comprising a plurality of alternating north and south magnetic poles. The ABS sensor also includes a housing mounted on the spindle of the wheel facing the disk. This housing accommodates a printed circuit board on which is mounted a Hall effect cell. This cell produces an electric current as a function of the magnetic field variations generated by the alternating passage in front of the housing of the north and south poles of the disk driven in rotation by the shaft. The ABS sensor thus operates as a magnetic coder of the rotation speed of the wheel, as is known in itself.

Further, it is known that the robustness and precision of monitoring of the operation of the vehicle are increased by using measurements of the acceleration, for example, vertical, of the vehicle wheels. Thus, this implies using an additional accelerometer mounted on each of the vehicle wheels.

However, mounting an accelerometer on a wheel is complicated because it requires a special housing and additional electrical connections for this sensor.

An objective of the present invention is to remedy the above-mentioned problem.

To this effect, an object of the invention is a device for measuring the rotation speed of a wheel, in particular a motor vehicle wheel, including:
a housing;
a printed circuit board accommodated in the housing; and
a coder cell mounted on the printed circuit board and sensitive to electromagnetic field variations,

characterized in that it comprises at least one accelerometer mounted on the printed circuit board and adapted to measure an acceleration according to at least one predetermined axis.

The device can also include one or several of the characteristics below, considered individually or according to all technically possible combinations:
it comprises means for extracting a component of the acceleration supplied by the at least one accelerometer, according to a second predetermined axis and as a function of a predetermined inclination angle;
the printed circuit board comprises a first and a second portions inclined with respect to one another by a predetermined angle, the coder cell being mounted on said first portion and the at least one accelerometer being mounted on said second portion;
the at least one accelerometer is mounted inclined by a predetermined angle with respect to the plane of the printed circuit board;
the at least one accelerometer is an accelerometer whose first axis is inclined by a predetermined angle with respect to the plane of its connection terminals;
the printed circuit board is a supple film card; and
the cell and the at least one accelerometer share a common electric supply line.

Another object of the invention is a vehicle wheel train, in particular of a motor vehicle, including a wheel mounted on a shaft and a system for measuring the rotation speed of the wheel, this system comprising a coder disk mounted on the shaft of the wheel, coupled with a device for measuring the rotation speed of a vehicle wheel, said device including:
a housing;
a printed circuit board accommodated in the housing; and
a coder cell mounted on the printed circuit board and sensitive to electromagnetic field variations, this coder cell being accommodated in the area of a front face of the housing facing the coder disk,

characterized in that it comprises at least one accelerometer mounted on the printed circuit board and adapted to measure an acceleration according to at least one predetermined axis.

The wheel train can also include one or several of the characteristics below, considered individually or according to all technically possible combinations:
it comprises means for extracting a component according to a second predetermined axis of the acceleration supplied by the at least one accelerometer, as a function of a predetermined inclination angle of the housing mounted on the vehicle wheel;
the first measurement axis of the at least one accelerometer is in a horizontal plane of the vehicle wheel;
the printed circuit board comprises a first portion inclined by a first predetermined angle with respect to a horizontal plane of the wheel and a second portions inclined by a second predetermined angle with respect to the portion so that the said second portion is in a horizontal plane of the vehicle wheel, the coder cell being mounted on said first portion and the at least one accelerometer being mounted on said second portion;
the at least one accelerometer is mounted inclined by a predetermined angle with respect to the plane of the printed circuit board so that the first measurement axis is in a horizontal plane of the vehicle wheel; and
the at least one accelerometer is an accelerometer whose first axis is inclined by a predetermined angle with respect to the plane of its connection terminals so as to be in a horizontal plane of the vehicle wheel.

The invention will be better understood by reading the following description, given by way of example only, with reference to the annexed drawings in which identical references designate identical or analogous elements, and in which:

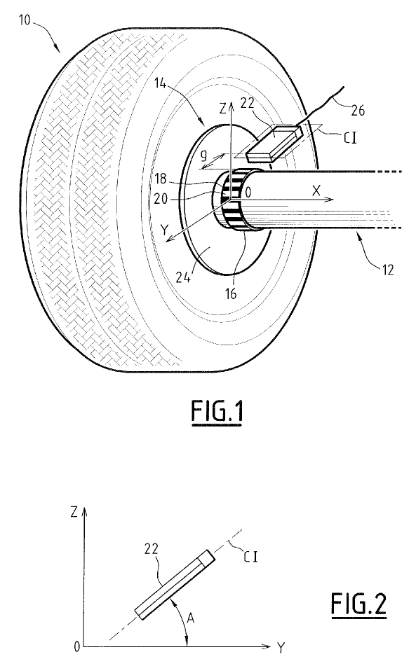

FIG. 1 is a schematic perspective view of a wheel train of a motor vehicle associated to a sensor housing according to the invention;

FIG. 2 is a lateral view of the housing of FIG. 1 in an orthogonal referential of the wheel;

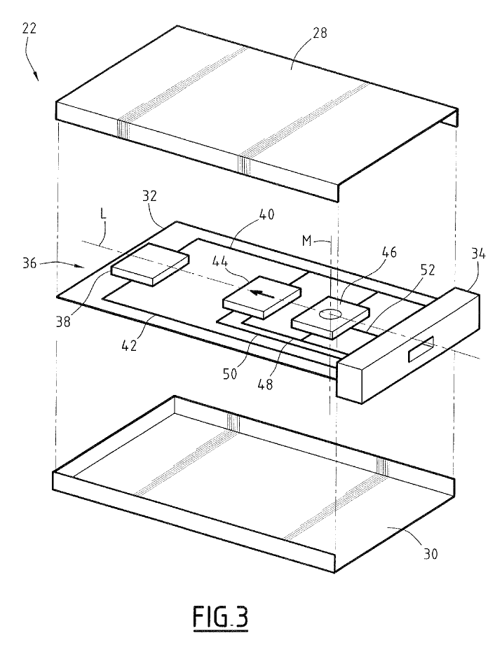

FIG. 3 is a schematic exploded perspective view of a first embodiment of the housing according to the invention;

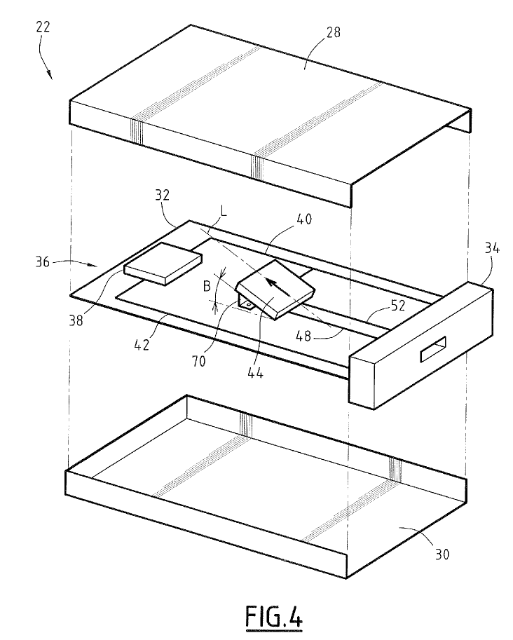

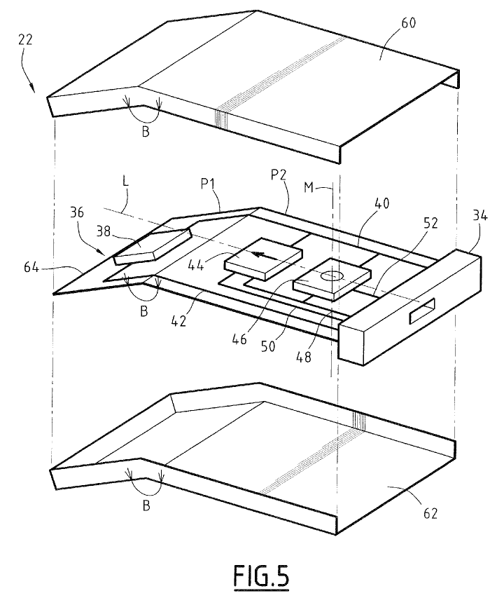

FIG. 4 is a schematic exploded perspective view of a second embodiment of the housing according to the invention; and

FIG. 5 is a schematic exploded perspective view of a third embodiment of the housing according to the invention.

FIG. 1 shows schematically a wheel train of a motor vehicle comprising a wheel 10 fixed at its center to a shaft 12 transmitting a rotation torque from an engine (not shown).

In a standard manner, the wheel 10 is referenced by an orthogonal referential OXYZ, the OX axis being the transverse axis of the wheel, the OY axis being the longitudinal axis of the wheel and the OZ axis being the vertical axis of the wheel, as is known in itself. The OXY plane is called horizontal plane of the wheel 10.

This wheel 10 is associated with a sensor 14 according to the invention that includes a coder disk 16 formed by a succession of alternating north 18 and south 20 magnetic poles. This disk 16 is mounted on the shaft 12.

The sensor 14 also comprises a sensor housing 22 fixed on a spindle 24 of the wheel 10 facing the coder disk 16 and separated from the coder disk by a gap distance g.

The housing 22 is electrically connected to a unit for monitoring the operation of the engine, or ECU (not shown), and to the electrical supply system of the vehicle (not shown) by an electrical cabling 26 for its supply in electrical energy and for the communication of data.

The housing 22 has a parallelepiped shape and accommodates a printed circuit board on a longitudinal plane Cl, as will be explained in more details below. Active elements are mounted on the printed circuit board and are adapted to measure the rotation speed of the wheel 10 as well as an acceleration according to at least one predetermined axis thereof, with a view at monitoring the anti-blocking system of the wheels (ABS), at monitoring the trajectory of the vehicle (ESP), or others.

Due to the arrangement of the various organs for the driving, braking, and turning of the wheel and for reasons of ease of assembly and electrical connections, as well known in the state of the art, the housing 22 is mounted inclined. The longitudinal plane Cl of the housing 22 on which the printed circuit board is arranged thus forms a predetermined and known angle A with respect to the horizontal plane OXY of the wheel 10, as is visible on FIG. 2, which is a side view of the housing in the referential OXY.

FIG. 3 is a schematic exploded perspective view of a first embodiment of the sensor housing 22.

This housing 22 is, for example, a rectangular parallelepiped formed by a top half-shell 28 and a bottom half-shell 30 and it accommodates in its central longitudinal plane a plane printed circuit board 32. This board 32 is connected to an electrical connection block 34 for its electrical supply and the transmission of signals via the electrical cabling 26.

In the area of the front face 36 of the housing 22, which faces the coder disk 16, a Hall effect coder cell 38 is mounted on the printed circuit board 32. As is known in itself, this cell 38 is sensitive to variations in the magnetic field generated by the successive passage of the magnetic poles 18, 20 of the disk 16 in front of the front face 36. The cell 38 thus produces an electrical current whose representative signal has a substantially crenelated shape and whose frequency depends on the spatial period of the poles on the disk 16 and the rotation speed of the wheel 10. The disk 16 and the cell 38 thus constitute an ABS sensor in the form of a magnetic coder of the rotation speed of the wheel 10.

The cell 38 is supplied with electrical energy by a supply line 40 connected to the connection block 34 and the electrical current that it generates is transmitted to the block 34 by a first data line 42.

A first mono-axis accelerometer 44 constituted, for example, by a technology of the microelectromechanical system (MEM) type in the form of a chip, is mounted on the printed circuit board 32 and is adapted to measure the acceleration to which the housing 22, and thus the wheel 10, are subjected along a predetermined axis L. In this embodiment, the axis L is a longitudinal axis of the board 32. This accelerometer 44 is provided to measure the longitudinal acceleration of the wheel 10.

A second mono-axis accelerometer 46 constituted, for example, by an microelectromechanical system in the form of a chip, is also mounted on the board 32 and is adapted to measure the acceleration to which the housing 22 is subjected along a predetermined axis M, which is here perpendicular to the plane of the board 32. This accelerometer 44 is provided to measure the vertical acceleration of the wheel 10.

The accelerometers 44 and 46 are connected to the line 40 to be supplied with electrical energy as well as to the ground line 48 connected to the block 34. Further, they are connected to a second and third data lines 50, 52, respectively, for the transmission of their acceleration measurements to the block 34.

Thus, it will be observed that only five electrical connections are required for the electrical supply and the data communication needs of the board 32.

As mentioned above, since the housing 22 is mounted on the vehicle wheel, the plane of the printed circuit board 32 is inclined by a known angle A with respect to the horizontal plane OXY of the wheel 10. In order to extract the component along the longitudinal axis OY of the wheel 10 from the measurement of the accelerometer 44, and the component along the vertical axis OZ of the wheel 10 from the measurement of the accelerometer 46, filtering means adapted to extract these components are provided.

These filtering means are, for example, provided in the ECU of the vehicle, and they multiply the measurement received from the accelerometer 46 by the cosinus of the angle A to extract the vertical acceleration of the wheel 10. Similarly, the filtering means multiply the measurement received from the accelerometer 44 by the sinus of the angle A to extract the longitudinal acceleration of the wheel 10.

As a variant, the filtering means are mounted on the board 32 in the form of a microcontroller chip.

FIG. 4 is a schematic view of a second embodiment of the housing 22 analogous to that of FIG. 1. In this embodiment, only the cell 38 and the accelerometer 44 are mounted on the printed circuit board 32.

Here, the chip of the accelerometer 44 is mounted inclined by an angle B substantially equal to the angle 180°-A (in degrees), with respect to the plane of the board 32, while being supported by appropriate support means 70. Thus, the measurement axis L of the accelerometer 44 is substantially in a horizontal plane of the wheel 10.

Thus, the accelerometer 44 measures directly the longitudinal acceleration of the wheel and it is not necessary to implement a filtering of the measurement.

As a variant, the chip of the accelerometer 44 is not mounted inclined on the board 32, but the accelerometer 44 measures the acceleration to which the board 32 is subjected along an axis forming the angle B with the plane of the connection pins of the chip. This type of accelerometer is generally called “inclined axis accelerometer.”

FIG. 5 is a schematic exploded perspective view of a third embodiment of the housing 22.

In this embodiment, the housing 22 is formed by an upper half-shell 60 and a lower half-shell 62 which is angled by an angle B. The housing 22 accommodates a printed circuit board 64, also angled by an angle B. The board 64 has a first portion P1 on which the coder cell 38 is mounted and a second portion P2 on which the accelerometers 44, 46 are mounted.

The board 64 is, for example, rigid, or it is formed by a supple film formed so as to form an L with the angle B.

The plane of the portion P1 of the board 64 forms the angle A with the horizontal plane OXY of the wheel 10. Thus, the portions P1 and P2 being inclined with respect to one another by the angle B, the portion P2 on which the accelerometers 44, 46 are mounted is substantially in a horizontal plane of the wheel 10.

Thus, the accelerometers 44 and 46 directly measure the longitudinal and vertical accelerations of the wheel, and thus, it is not necessary to implement a filtering of their measurements.

As a variant, in the third embodiment, the housing 22 is a rectangular parallelepiped comprising appropriate supporting and/or fixing means for the angled printed circuit board 64.

Thus, according to the invention, a sensor of the rotation speed of a vehicle wheel and of the acceleration thereof has been obtained, which is compact, which comprises a unique housing and a limited number of electrical connections.

Even though a connection block 34 integrated to the sensor housing has been described, as a variant, the connection block is shifted to the area of the ECU of the vehicle.

Similarly, even though a motor vehicle wheel has been described, it is understood that the invention applies to any type of motor vehicle, for example, a motorbike, a multi-train vehicle (truck), or others.

Similarly, even though an ABS sensor has been described in the form of a magnetic coder of the rotation speed of the wheel, as a variant, the ABS sensor is an optical coder, comprising a toothed disk associated with means for emitting a light beam disposed facing the sensor housing on the other side of the disk and the coder cell is sensitive to luminosity variations, and thus of the electromagnetic field, triggered by the successive passages of the teeth of the disk, as is known in itself.

1. Device for measuring the rotation speed of a wheel, in particular a motor vehicle wheel, including:
a housing;
a printed circuit board accommodated in the housing; and
a coder cell mounted on the printed circuit board and sensitive to variations of the electromagnetic field,
wherein said device comprises at least one accelerometer mounted on the printed circuit board and adapted to measure an acceleration according to at least one predetermined axis.

2. Device according to claim 1, comprising means for extracting a component of the acceleration supplied by the at least one accelerometer, according to a second predetermined axis and as a function of a predetermined inclination angle (A).

3. Device according to claim 1, wherein the printed circuit board comprises a first and a second portions inclined with respect to one another by a predetermined angle, the coder cell being mounted on said first portion and the at least one accelerometer being mounted on said second portion.

4. Device according to claim 1, wherein the at least one accelerometer is mounted inclined by a predetermined angle with respect to the plane of the printed circuit board.

5. Device according to claim 1, wherein the at least one accelerometer is an accelerometer whose first axis is inclined by a predetermined angle with respect to the plane of its connection terminals.

6. Device according to claim 1, wherein the printed circuit board is a supple film card.

7. Device according to claim 1, wherein the cell and the at least one accelerometer share a common electric supply line.

8. Vehicle wheel train, in particular of a motor vehicle, including a wheel mounted on a shaft and a system for measuring the rotation speed of the wheel, this system comprising a coder disk mounted on the shaft coupled with a device for measuring the rotation speed of a wheel, said device including:
a housing;
a printed circuit board accommodated in the housing; and
a coder cell mounted on the printed circuit board and sensitive to variations of the electromagnetic field generated by the coder disk, this coder cell being accommodated in the area of a front face of the housing facing the coder disk,
wherein the vehicle wheel train comprises at least one accelerometer mounted on the printed circuit board and adapted to measure an acceleration according to at least one predetermined axis.

9. Wheel train according to claim 8, comprising means for extracting a component according to a second predetermined axis of the acceleration supplied by the at least one accelerometer, as a function of a predetermined inclination angle of the housing mounted on the vehicle wheel.

10. Wheel train according to claim 8, wherein the first measurement axis of the at least one accelerometer is in a horizontal plane of the vehicle wheel.

11. Wheel train according to claim 10, wherein the printed circuit board comprises a first portion inclined by a first predetermined angle with respect to a horizontal plane of the wheel and a second portion inclined by a second predetermined angle with respect to the portion so that the said second portion is in a horizontal plane of the vehicle wheel, the coder cell being mounted on said first portion and the at least one accelerometer being mounted on said second portion.

12. Wheel train according to claim 10, wherein at least one accelerometer is mounted inclined by a predetermined angle with respect to the plane of the printed circuit board so that the first measurement axis is in a horizontal plane of the vehicle wheel.

13. Wheel train according to claim 10, characterized in that the at least one accelerometer is an accelerometer whose first axis is inclined by a predetermined angle with respect to the plane of its connection terminals so as to be in a horizontal plane of the vehicle wheel.
